(19) United States
(12) Patent Application Publication
(10) Pub. No.: US 2007/0237203 A1
(43) Pub. Date: Oct. 11, 2007

(54) Cooking pan with integral temperature measurement apparatus

(76) Inventor: Leona June Gipson, Sudan, TX (US)

Correspondence Address: David O. Simmons;GALASSO & ASSOCIATES, LP, P.O. Box 26503, Austin, TX, 78755-0503, US

(21) Appl. No.: 11/401,174

(22) Filed: Apr. 10, 2006

(51) Int. Cl. G01K 1/14

(52) U.S. Cl. 374/150; 374/141

(57) ABSTRACT

A temperature-indicating cooking pan apparatus comprises a container portion, a handle portion and a mechanical temperature measurement device. The container portion has a closed end and an open end. The handle portion is connected to and extends from the container portion adjacent the open end of the container portion. The mechanical temperature measurement device has a temperature gauge portion attached to the handle portion, a fluid reservoir within the container portion adjacent the closed end of the container portion and a capillary tube portion connected between the fluid reservoir and the temperature gauge portion.

### FIELD OF THE DISCLOSURE

The disclosures made herein relate generally to cookware and, more particularly, to cooking thermometers, pots and pans.

### BACKGROUND

In cooking some foods it is necessary to monitor the temperature of a liquid inside a cooking vessel (e.g., a cooking pan) very closely. Such foods can be and often are, sensitive to the temperature to which they are heated and the amount of time the temperature is maintained. An example of such a food is candy.

Temperature monitoring of the liquid is presently accomplished by probing a discreet cooking thermometer into the heated liquid to measure temperature. Often a clip is incorporated into the thermometer to allow the user to hang the thermometer onto the side of the cooking pan. This arrangement can be frustrating to use, as the thermometer is prone to falling inside the cooking pan (and the liquid contained therein), or falling outside the cooking pan and onto the cooking surface. In addition, if the thermometer falls outside the cooking pan, it often spatters the heated liquid about the cooking area, which can be dangerous.

Therefore, a device that overcomes drawbacks associated with conventional cooking thermometers would be useful, advantageous and novel.

### SUMMARY OF THE DISCLOSURE

In one embodiment of the present invention, a temperature-indicating cooking pan apparatus comprises a container portion, a handle portion and a temperature measurement device. The handle portion is connected to and extends from the container portion. The temperature measurement device has a temperature gauge portion attached to the handle portion and a temperature sensing portion within the container portion.

In another embodiment of the present invention, a temperature-indicating cooking pan apparatus comprises a container portion, a handle portion and a mechanical temperature measurement device. The container portion has a closed end and an open end. The handle portion is connected to and extends from the container portion adjacent the open end of the container portion. The mechanical temperature measurement device has a temperature gauge portion attached to the handle portion, a fluid reservoir within the container portion adjacent the closed end of the container portion and a capillary tube portion connected between the fluid reservoir and the temperature gauge portion.

In another embodiment of the present invention, a handle assembly for a cooking pan apparatus comprises a cooking pan handle and a temperature measurement device. The cooking pan handle has a first end portion and a second end portion. The second end portion is configured for being attached to a container portion of a cooking man assembly. The temperature measurement device has a temperature gauge portion, a temperature sensing portion and a conductor portion connected between the temperature gauge portion and the temperature sensing portion. The temperature gauge portion is attached to the cooking pan handle between the end portions of the cooking pan handle. The conductor portion extends from the second end portion of the cooking pan handle.

Turning now to specific aspects of the present invention, in at least one embodiment, the temperature measurement device is a mechanical temperature measurement device having a temperature gauge portion attached to the handle portion, a fluid reservoir within the container portion and a capillary tube portion connected between the fluid reservoir and the temperature gauge portion.

In at least one embodiment of the present invention, indicia indicating various temperature levels are provided on the handle portion.

In at least one embodiment of the present invention, the temperature gauge portion is exposed within a window in the handle portion and the indicia are provided on the handle portion adjacent the window.

In at least one embodiment of the present invention, the capillary tube portion of the temperature measurement device is at least partially within an internal passage in a sidewall of the container portion.

In at least one embodiment of the present invention, the temperature sensing portion of the temperature measurement device is at least partially within the internal passage in the sidewall of the container portion.

In at least one embodiment of the present invention, the handle portion includes a first segment fixedly attached to the container portion and a second segment extends from the first segment and the window is within the first segment of the handle portion.

These and other objects, embodiments, advantages and/or distinctions of the present invention will become readily apparent upon further review of the following specification, associated drawings and appended claims.

### BRIEF DESCRIPTION OF THE DRAWINGS

FIG. 1 depicts a cooking pan with integral temperature measurement apparatus in accordance with the present invention.

FIG. 2 is a cross-sectional view taken along the line 2-2 in FIG. 1.

### DETAILED DESCRIPTION OF THE DRAWING FIGURES

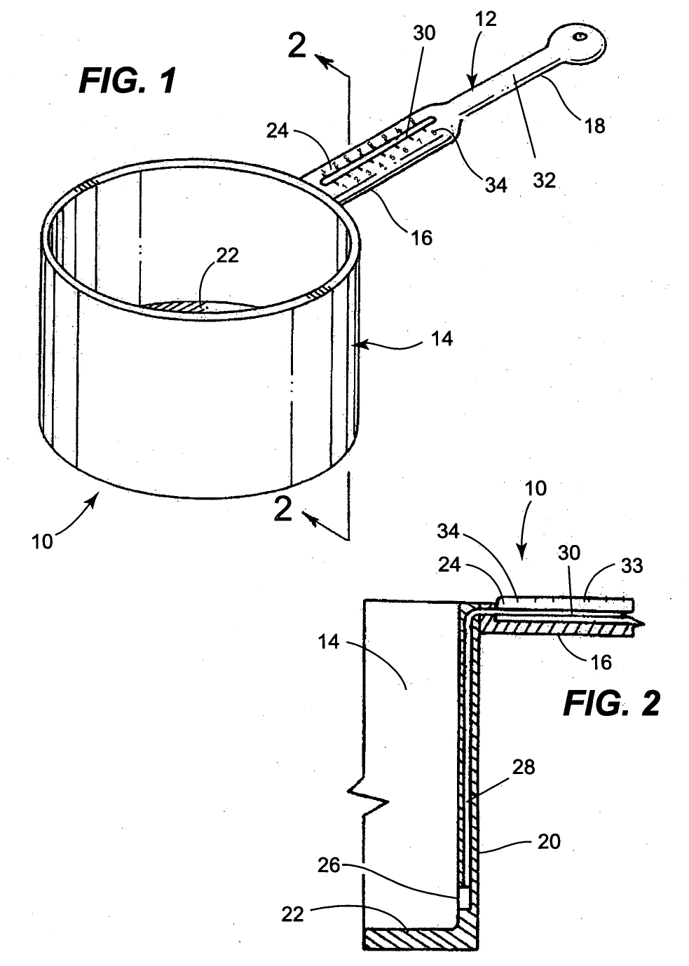

FIG. 1 depicts an embodiment of a cooking pan with integral thermometer configured in accordance with the present invention, which is referred to herein as the cooking pan 10. The cooking pan 10 comprises a handle portion 12 and a container portion 14. The handle portion 12 includes a first segment 16 and a second segment 18. The first segment 16 is fixedly attached to the container portion 14 and the second segment 18 extends from the first segment 16.

Referring now to FIGS. 1 and 2, the container portion 14 includes a side wall 20 and a bottom wall 22. A temperature measurement device 24 includes a temperature sensing portion 26, a conductor portion 28 and a temperature gauge portion 30. The temperature sensing portion 26 is integrated into a passage of the side wall 20 near the bottom wall 22 of the container portion. 14. The temperature gauge portion 30 is imbedded into the first segment 16 of the handle portion 12. The conductor portion 28 is incorporated into the side wall 20 of the container portion 14 and is connects between the temperature sensing portion 26 and the temperature gauge portion 30.

FIG. 1 depicts measurement indicia 34 (i.e., temperature level indicators) provided on the first segment 16 of the handle portion 12. Multiple sets of measurement indicia 30 are indicated in FIG. 1. Each set of measurement indicia 34 are oriented so opposite each other to enable the user to read at least one set of measurement indicia 34 with the handle to the right or left of the pan (as viewed from above the pan). It is contemplated herein that the measurement indicia 34 may be displayed in any orientation or scale (e.g., to enable the user to more easily read the measurement indicia 34 while using the cooking pan 10). While numeric measurement indicia 34 are depicted, it is further contemplated that the measurement indicia 34 may by of a numeric-type, an alphabetic type (e.g., cool, boil, burn), or a symbolic type (e.g., graduated color scale).

As depicted in FIGS. 1 and 2, the temperature measurement device 24 is of a mechanical type that utilizes a fluid with a relatively high rate of thermal expansion. The fluid is visible within the temperature gauge portion 30 of the temperature measurement device 24. Liquid inside the container portion 14 contacts the temperature sensing portion 26 (e.g., a fluid reservoir), causing the fluid inside the temperature sensing portion 26 to expand a proportional amount based upon the fluid temperature into the conductor portion 28 (e.g., a capillary tube). The temperature is then read via the indicia 34 where the fluid ends within the temperature gauge portion 30 (e.g., read via graduated, uniformly spaced indicia). It is contemplated herein that the temperature gauge portion 30 may be of a graduated angular-type (e.g., a needle and face) rather than a graduated linear-type, wherein pressure associated with expansion of the fluid exerts a corresponding force causing rotation of the needle.

In addition, it is contemplated herein that the temperature measurement device 24 may be of a digital type that utilizes an electrical sensor as the temperature sensing portion 26, wire as the conductor portion 28 and a digital readout as the temperature gauge portion 30. Alternatively, the temperature measurement device 24 may be of an infrared-type. That is, temperature of the liquid inside the container portion 14 is measured via infrared radiation rather than via a temperature sensing portion 26 and conductor portion 28.

As shown in FIG. 1, the container portion 14 is of a cylindrical shape. However, it is contemplated herein that the container portion 14 could be of any shape or depth. As depicted in FIG. 1, the handle portion 12 is of an elongated shape. However, it is contemplated herein that the handle portion 12 may be of any shape. In addition, there may be a plurality of handle portions 12 that may or may not include a temperature gauge portion 30.

As shown in FIG. 1, the first segment 16 of the handle portion 12 includes the temperature gauge portion 30 and the second segment 18 of the handle portion 12 includes a hand gripping portion 32. It is contemplated herein that the first segment 16 of the handle portion 12 may include the hand gripping portion 32 and the second segment 18 of the handle portion 12 may include the temperature gauge portion 30.

As shown in FIG. 1, the temperature gauge portion 30 is located on the first segment 16 of the handle portion 12 and the hand gripping portion 32 is located on the second segment 18 of the handle portion 12 to enable the user to view the temperature gauge portion 30 while holding the hand gripping portion 32 (i.e., the user's hand, while holding the hand gripping portion 32, does not obstruct the temperature gauge portion 30). The temperature gauge portion 30 is exposed within a window 33 (FIG. 2) of the handle portion 12. The temperature gauge portion 30 is oriented on the first segment 16 of the handle portion 12 (e.g., on the top) to enable the user to read the temperature gauge portion 30 when using the cooking pan 10. However, it is contemplated herein that the temperature gauge portion 30 may be located and oriented in any manner to enable the user to read the temperature gauge portion 30 when using the cooking pan 10.

As depicted in FIGS. 1 and 2, the conductor portion 28 and the temperature sensing portion 26 are embedded within the side wall 20 of the container portion 14. Alternatively, the conductor portion 28 and the temperature sensing portion 26 are located within an interior portion of the container portion 14 (i.e., not embedded within the side wall 20 of the container portion 14). Such an alternate configuration enables the handle portion 12 and the temperature measurement device 24 to be fabricated as an assembly, separately from the container portion 14 and then attached to the container portion 14.

In the preceding detailed description, reference has been made to the accompanying drawings that form a part hereof and in which are shown by way of illustration specific embodiments in which the present invention may be practiced. These embodiments and certain variants thereof, have been described in sufficient detail to enable those skilled in the art to practice embodiments of the present invention. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications and equivalents, as can be reasonably included within the spirit and scope of the appended claims.

What is claimed is:

1. A temperature-indicating cooking pan apparatus, comprising:
a container portion;
a handle portion connected to and extending from the container portion; and
a temperature measurement device having a temperature gauge portion attached to the handle portion and a temperature sensing portion within the container portion.

2. The apparatus of claim 1 wherein the temperature measurement device is a mechanical temperature measurement device having a temperature gauge portion attached to the handle portion, a fluid reservoir within the container portion and a capillary tube portion connected between the fluid reservoir and the temperature gauge portion.

3. The apparatus of claim 2, further comprising:
indicia provided on the handle portion, wherein the temperature gauge portion is exposed within a window in the handle portion, wherein said indicia are provided on the handle portion adjacent the window and wherein said indicial indicates various temperature levels.

4. The apparatus of claim 3 wherein:
the capillary tube portion of the temperature measurement device is at least partially within an internal passage in a sidewall of the container portion; and
the temperature sensing portion of the temperature measurement device is at least partially within the internal passage in the sidewall of the container portion.

5. The apparatus of claim 4 wherein:
the handle portion includes a first segment fixedly attached to the container portion and a second segment extends from the first segment; and
the window is within the first segment of the handle portion.

6. The apparatus of claim 1, further comprising:
indicia provided on the handle portion, wherein the temperature gauge portion is exposed within a window in the handle portion, wherein said indicia are provided on the handle portion adjacent the window and wherein said indicial indicates various temperature levels.

7. A temperature-indicating cooking pan apparatus, comprising:
a container portion having a closed end and an open end;
a handle portion connected to and extending from the container portion adjacent the open end of the container portion; and
a mechanical temperature measurement device having a temperature gauge portion attached to the handle portion, a fluid reservoir within the container portion adjacent the closed end of the container portion and a capillary tube portion connected between the fluid reservoir and the temperature gauge portion.

8. The apparatus of claim 7, further comprising:
indicia provided on the handle portion, wherein the temperature gauge portion is exposed within a window in the handle portion, wherein said indicia are provided on the handle portion adjacent the window and wherein said indicial indicates various temperature levels.

9. The apparatus of claim 8 wherein:
the capillary tube portion of the temperature measurement device is at least partially within an internal passage in a sidewall of the container portion; and
the temperature sensing portion of the temperature measurement device is at least partially within the internal passage in the sidewall of the container portion.

10. The apparatus of claim 9 wherein:
the handle portion includes a first segment fixedly attached to the container portion and a second segment extends from the first segment; and
the window is within the first segment of the handle portion.

11. The apparatus of claim 7 wherein:
the capillary tube portion of the temperature measurement device is at least partially within an internal passage in a sidewall of the container portion; and
the temperature sensing portion of the temperature measurement device is at least partially within the internal passage in the sidewall of the container portion.

12. A handle assembly for a cooking pan apparatus, comprising:
a cooking pan handle having a first end portion and a second end portion, wherein the second end portion is configured for being attached to a container portion of a cooking man assembly; and
a temperature measurement device having a temperature gauge portion, a temperature sensing portion and a conductor portion connected between the temperature gauge portion and the temperature sensing portion, wherein the temperature gauge portion is attached to the cooking pan handle between said end portions of the cooking pan handle and wherein the conductor portion extends from the second end portion of the cooking pan handle.

13. The apparatus of claim 12 wherein the temperature measurement device is a mechanical temperature measurement device having a temperature gauge portion attached to the handle portion, a fluid reservoir within the container portion and a capillary tube portion connected between the fluid reservoir and the temperature gauge portion.

14. The apparatus of claim 13, further comprising:
indicia provided on the handle portion, wherein the temperature gauge portion is exposed within a window in the handle portion, wherein said indicia are provided on the handle portion adjacent the window and wherein said indicial indicates various temperature levels.

15. The apparatus of claim 14 wherein:
the capillary tube portion of the temperature measurement device is at least partially within an internal passage in a sidewall of the container portion; and
the temperature sensing portion of the temperature measurement device is at least partially within the internal passage in the sidewall of the container portion.

16. The apparatus of claim 15 wherein:
the handle portion includes a first segment fixedly attached to the container portion and a second segment extends from the first segment; and
the window is within the first segment of the handle portion.

17. The apparatus of claim 12, further comprising:

18. indicia provided on the handle portion, wherein the temperature gauge portion is exposed within a window in the handle portion, wherein said indicia are provided on the handle portion adjacent the window and wherein said indicial indicates various temperature levels.
